(19) United States
(12) Patent Application Publication
(10) Pub. No.: US 2006/0221196 A1
(43) Pub. Date: Oct. 5, 2006

(54) Stereography systems and methods

(76) Inventor: Barney P. Johnson, Canton, GA (US)

Correspondence Address: PAPARELLA & ASSOCIATES, PLC, 930 N. WASHINGTON AVE., LANSING, MI, 48906, US

(21) Appl. No.: 11/094,002

(22) Filed: Mar. 29, 2005

(51) Int. Cl. H04N 5/225

(52) U.S. Cl. 348/218.1

(57) ABSTRACT

A method for implementing stereography includes: providing an image depicting a first plurality of object images along a first straight line and a second plurality of object images along a second straight line, wherein the distance between each pair of adjacent object images is substantially equal to the distance between each other pair of adjacent object images along each of the first and second straight lines, respectively, and wherein each object is substantially identical to, and has substantially the same orientation as, each of its adjacent object images, and providing an instruction instructing a viewer to look at the image in a cross-eyed manner.

### BACKGROUND

Stereography in the broadest sense is the term used for methods to create an illusion of depth from two-dimensional images. Although some traditional methods involving monocular depth cues in images such as perspective, shading, shadows, relative size, etc. may give the viewer a sense of depth, they are not usually described as stereographic methods. There are also some stereographic methods which utilize mechanisms such as Holography, Chromastereography, the Pulfrich Effect and Wobble. However, stereographic methods mostly rely on binocular disparity.

Human eyes, being separated approximately 2.5 inches, provide two different views of a real object or scene. The human brain combines these views into one perceived image. While doing so, it uses the slight differences in images from the left and right eyes to provide a depth cue.

This cue is combined with monocular cues, motion cues, physiological cues such as eye muscle contraction and convergence, and information stored from previous experience in order for the brain to arrive at a complete evaluation of depth. All cues need not be present for the brain to put together a coherent picture, but the sense of depth will be lessened with fewer cues, and confusion results if one or more of the cues actually contradicts the others. Many optical illusions are dependant on this principle.

When looking at a photograph or flat image, there is no binocular disparity to provide a depth cue. However, if many monocular cues are present we can still detect depth. For example, excellent computer graphics with models, character and scene shading, reflection, shadows, and in the case of animation, motion parallax, can give, with a bit of imagination on the viewer's part, quite a sense of realism. Although not quite 3D (though some use this term loosely), this effect has come to be referred to more often as 2½D.

Although some believe there is evidence from ancient Greece and some renaissance era paintings of the use of binocular disparity to create a depth effect, the first documented, widely accepted and popular use was by Sir Charles Wheatstone in the mid-1800s with the introduction of stereo pairs viewed with the aid of his reflecting Stereoscope. In this case, two pictures were taken of the same scene from positions a few inches apart, thereby replicating the views of a right and a left eye. The Stereoscope presented the corresponding picture to the correct eye and the viewer would perceive depth. It was quite a hit in Victorian England.

Over the years innovations were made to cameras, picture taking, and presentation methods. One method for viewing, “free-viewing” or “free-fusion” actually required no equipment, but simply had the viewer relax the eyes (parallel viewing) or cross them (cross-eyed viewing). But the underlying concept for stereographic imaging remained the same: take two pictures of the same scene from two viewpoints and present the appropriate picture to each eye. In the most general term, this technique is described as Stereo Pairing or Stereo Photography.

About the same time as Wheatsone, Sir David Brewster discovered that while free-viewing a repeating pattern in Victorian wallpaper, it appeared to sink away from the wall. Small imperfections in the wallpaper sometimes caused the horizontal spacing of repeating elements to vary slightly. Where this happened the elements seemed to sink or float at different focal planes. This is now termed the “wallpaper effect” and stereographic images utilizing this principle are deemed Wallpaper Type Stereograms.

In the late 1950s, Dr. Bela Julesz demonstrated a sense of depth could be developed from a flat image using binocular disparity with no other depth cues present. He did this by placing two similar images of random dots side by side. On one of the images he horizontally displaced some of the dots. When examined by free-viewing, the images merged to one, but binocular disparity created by the displaced dots caused the viewer to perceive the dots floating in front of or sinking below the focal plane containing the non-displaced dots.

Later in 1979, Christopher Tyler, a very clever fellow, placed several similar random dot images adjacent to one another to look like a single image, then manipulated the dots in such a way that when free-viewed, a hidden image emerged. Although in reality this was just a variation of Wallpaper Type Stereograms this became known as SIRDS, Single Image Random Dot Stereogram, and was the basis for the stereogram craze in the 1990s.

Because the depth effect was determined by horizontal displacement of dots, the math involved to create a hidden figure was quite intensive. Computers became essential. Algorithms were developed by Tyler and others to calculate the displacement of dots to create the desired effect. Many of these involved using a grayscale image, or “depth map”, of the hidden object, with the degree of shading indicating the desired depth of any particular point. The program would evaluate the brightness of a pixel in the depth map, calculate the displacement needed to create the binocular disparity to cause the correct sense of depth, then shift the pixels accordingly.

Current stereography systems and methods are complicated and expensive to implement. Therefore, there exists a need for stereography systems and methods that address these and/or other problems associated with prior art stereography. For example, there exists a need for stereography systems and methods that are simpler and less expensive to implement.

### SUMMARY OF THE INVENTION

The present invention provides systems and methods for generating and viewing images. A method according to one embodiment includes: placing a plurality of objects along a straight line, wherein the distance between each pair of adjacent objects is substantially equal to the distance between each other pair of adjacent objects, and wherein each object is substantially identical to (and has substantially the same orientation as) each of its adjacent objects, and taking a picture of the plurality of objects using a camera, wherein a lens of the camera is aligned substantially parallel to the first and second straight lines.

A method according to another embodiment includes: placing a plurality of objects along a straight line, wherein the distance between each pair of adjacent objects is substantially equal to the distance between each other pair of adjacent objects, and wherein each object is substantially identical to (and has substantially the same orientation as) each of its adjacent objects, and taking a plurality of pictures of the plurality of objects using a camera situated at a plurality of corresponding distances from the plurality of objects and has a plurality of corresponding fields of view.

A method according to another embodiment includes: placing a first plurality of objects along a first straight line, wherein the distance between each pair of adjacent objects is substantially equal to the distance between each other pair of adjacent objects along the first straight line, and wherein each object is substantially identical to (and has substantially the same orientation as) each of its adjacent objects, placing a second plurality of objects along a second straight line that is substantially parallel to the first straight line, wherein the distance between each pair of adjacent objects is substantially equal to the distance between each other pair of adjacent objects along the second straight, and wherein each object is substantially identical to (and has substantially the same orientation as) each of its adjacent objects, and taking a picture of the first and second plurality of objects using a camera, wherein a lens of the camera is aligned substantially parallel to the first and second straight lines.

A method according to another embodiment includes: placing a first plurality of objects along a first straight line, wherein the distance between each pair of adjacent objects is substantially equal to the distance between each other pair of adjacent objects along the first straight line, and wherein each object is substantially identical to (and has substantially the same orientation as) each of its adjacent objects, placing a second plurality of objects along a second straight line that is substantially parallel to the first straight line, wherein the distance between each pair of adjacent objects is substantially equal to the distance between each other pair of adjacent objects along the second straight, and wherein each object is substantially identical to (and has substantially the same orientation as) each of its adjacent objects, and taking a plurality of pictures of the first and second plurality of objects using a camera situated at a plurality of corresponding distances from the plurality of objects and has a plurality of corresponding fields of view.

A method according to another embodiment includes: providing an image depicting a plurality of objects along a straight line, wherein the distance between each pair of adjacent objects is substantially equal to the distance between each other pair of adjacent objects, and wherein each object is substantially identical to (and has substantially the same orientation as) each of its adjacent objects, and providing an instruction (e.g., written or oral) instructing a viewer to look at the image in a cross-eyed manner.

A method according to another embodiment includes: providing an image depicting a plurality of objects along a straight line, wherein the distance between each pair of adjacent objects is substantially equal to the distance between each other pair of adjacent objects, and wherein each object is substantially identical to (and has substantially the same orientation as) each of its adjacent objects, and providing an instruction (e.g., written or oral) instructing a viewer to look at the image via a viewing device configured to enable the viewer to view the image in a manner that corresponds to viewing the image in a cross-eyed manner.

A method according to another embodiment includes: providing an image depicting a first plurality of objects along a first straight line and a second plurality of objects along a second straight line, wherein the distance between each pair of adjacent objects is substantially equal to the distance between each other pair of adjacent objects along each of the first and second straight lines, respectively, and wherein each object is substantially identical to (and has substantially the same orientation as) each of its adjacent objects, and providing an instruction (e.g., written or oral) instructing a viewer to look at the image in a cross-eyed manner.

A method according to another embodiment includes: providing an image depicting a first plurality of objects along a first straight line and a second plurality of objects along a second straight line, wherein the distance between each pair of adjacent objects is substantially equal to the distance between each other pair of adjacent objects along each of the first and second straight lines, respectively, and wherein each object is substantially identical to (and has substantially the same orientation as) each of its adjacent objects, and providing an instruction (e.g., written or oral) instructing a viewer to look at the image via a viewing device configured to enable the viewer to view the image in a manner that corresponds to viewing the image in a cross-eyed manner.

A method according to another embodiment includes: receiving user input corresponding to an object, and providing an image depicting a plurality of said objects along a straight line, wherein the distance between each pair of adjacent objects is substantially equal to the distance between each other pair of adjacent objects, and wherein each object is substantially identical to (and has substantially the same orientation as) each of its adjacent objects.

A method according to another embodiment includes: receiving user input corresponding to a first object, receiving user input corresponding to a second object, and providing an image depicting a first plurality of objects along a first straight line and a second plurality of objects along a second straight line, wherein each of the first plurality of objects corresponds to the first object, wherein each of the second plurality of objects corresponds to the second objects, wherein the distance between each pair of adjacent objects is substantially equal to the distance between each other pair of adjacent objects along each of the first and second straight lines, respectively, and wherein each object is substantially identical to (and has substantially the same orientation as) each of its adjacent objects.

A method according to another embodiment includes: receiving an image depicting a plurality of objects along a straight line, wherein the distance between each pair of adjacent objects is substantially equal to the distance between each other pair of adjacent objects, and wherein each object is substantially identical to (and has substantially the same orientation as) each of its adjacent objects, and viewing the image in a cross-eyed manner.

A method according to another embodiment includes: receiving an image depicting a plurality of objects along a straight line, wherein the distance between each pair of adjacent objects is substantially equal to the distance between each other pair of adjacent objects, and wherein each object is substantially identical to (and has substantially the same orientation as) each of its adjacent objects, and viewing the image via a viewing device configured to enable the viewer to view the image in a manner that corresponds to viewing the image in a cross-eyed manner.

A method according to another embodiment includes: receiving an image depicting a first plurality of objects along a first straight line and a second plurality of objects along a second straight line, wherein the distance between each pair of adjacent objects is substantially equal to the distance between each other pair of adjacent objects along each of the first and second straight lines, respectively, and wherein each object is substantially identical to (and has substantially the same orientation as) each of its adjacent objects, and viewing the image in a cross-eyed manner.

A method according to another embodiment includes: receiving an image depicting a first plurality of objects along a first straight line and a second plurality of objects along a second straight line, wherein the distance between each pair of adjacent objects is substantially equal to the distance between each other pair of adjacent objects along each of the first and second straight lines, respectively, and wherein each object is substantially identical to (and has substantially the same orientation as) each of its adjacent objects, and viewing the image via a viewing device configured to enable the viewer to view the image in a manner that corresponds to viewing the image in a cross-eyed manner.

A method according to another embodiment includes: placing a plurality of objects along a straight line, wherein the distance between each pair of adjacent objects is substantially equal to the distance between each other pair of adjacent objects, and wherein each object is substantially identical to (and has substantially the same orientation as) each of its adjacent objects, and taking a plurality of pictures of the plurality of objects using a camera situated at a plurality of corresponding angles relative to an axis that is substantially parallel to the straight line.

A method according to another embodiment includes: placing a first plurality of objects along a first straight line, wherein the distance between each pair of adjacent objects is substantially equal to the distance between each other pair of adjacent objects along the first straight line, and wherein each object is substantially identical to (and has substantially the same orientation as) each of its adjacent objects, placing a second plurality of objects along a second straight line that is substantially parallel to the first straight line, wherein the distance between each pair of adjacent objects is substantially equal to the distance between each other pair of adjacent objects along the second straight, and wherein each object is substantially identical to (and has substantially the same orientation as) each of its adjacent objects, and taking a plurality of pictures of the first and second plurality of objects using a camera situated at a plurality of corresponding angles relative to an axis that is substantially parallel to the first and second straight lines.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1A depicts an image viewing method according to an embodiment of the invention.

FIG. 1B depicts an image viewing method according to another embodiment of the invention.

FIG. 2A depicts a row of objects and a row of corresponding virtual images, according to an embodiment of the invention.

FIG. 2B depicts objects positioned according to one embodiment of the invention.

FIG. 3A depicts a camera that is configured to capture an image of a row of objects.

FIG. 3B depicts a camera that is configured to capture a plurality of images of one or more rows of objects.

FIG. 3C depicts a camera that is configured to capture a plurality of images of a row of objects.

FIG. 4A is a flow chart depicting a method according to an embodiment of the invention.

FIG. 4B is a flow chart depicting another method according to an embodiment of the invention.

FIG. 4C is a flow chart depicting another method according to an embodiment of the invention.

FIG. 4D is a flow chart depicting another method according to an embodiment of the invention.

FIG. 5A is a flow chart depicting another method according to an embodiment of the invention.

FIG. 5B is a flow chart depicting another method according to an embodiment of the invention.

FIG. 5C is a flow chart depicting another method according to an embodiment of the invention.

FIG. 5D is a flow chart depicting another method according to an embodiment of the invention.

FIG. 6A is a flow chart depicting another method according to an embodiment of the invention. FIG. 6B is a flow chart depicting another method according to an embodiment of the invention.

FIG. 7A is a flow chart depicting another method according to an embodiment of the invention.

FIG. 7B is a flow chart depicting another method according to an embodiment of the invention.

FIG. 7C is a flow chart depicting another method according to an embodiment of the invention.

FIG. 7D is a flow chart depicting another method according to an embodiment of the invention.

FIG. 8A is a flow chart depicting another method according to an embodiment of the invention.

FIG. 8B is a flow chart depicting another method according to an embodiment of the invention.

FIG. 9 is a block diagram depicting a non-limiting example of a computer system (CS) that can be used to implement the methods depicted in FIGS. 6A-6C.

FIGS. 10A-10D depict respective views or images (perspective, top, front, and side views, respectively) of an example object arrangement in accordance with an embodiment of the invention.

FIGS. 11A-11C depict respective camera views or images of an object arrangement in accordance with an embodiment of the invention.

### DETAILED DESCRIPTION OF THE PREFERRED EMBODIMENTS

According to one embodiment, identical (or near identical) real objects are arranged in horizontal rows. If desired, the objects may be arranged in a plurality of rows. Different objects may be utilized for different rows, but the horizontal spacing of objects is the same for all rows. The rows are configured to be parallel to each other. Then, with the camera lens parallel to the rows, a photograph is taken.

Because of perspective, objects in rows farther away will be captured on film as being closer together than those in rows closer to the camera. In effect, a stereogram is created. However the spacing of objects, which establishes the depth effect, is not determined by algorithm, but rather by perspective.

The degree of perspective, hence the depth effect, is controlled by (1) the distance the camera is from the scene, and (2) the field of view. When the distance is large and the field of view is narrow, binocular disparity caused by perspective is low, so the image looks relatively flat. As the camera is moved closer and the field of view is widened, the effect of perspective grows and image looks more three dimensional. If the camera is extremely close and the field of view is very wide, perspective causes vast distortion, sometimes such that there is too much binocular disparity for the brain to resolve and the scene is not coherent.

The same technique is used when employing computer software to construct the scene to be digitally captured. 3D modeling software such as 3DS Max, Lightwave, Maya, Cool 3D Studio, Zuma and others are excellent for creating scenes with realistic looking objects and many monocular cues. The scenes consist of rows of 3D models which are uniformly spaced horizontally, and placed at the desired depth, Z.

Adjustments are then made to the distance the camera is away from the scene and the field of view to achieve spacing between elements as a natural consequence of perspective. When viewed using the cross eyed technique, the non-uniformity of spacing results in the stereographic effect and depth is perceived.

The normal depth cues created by the 3D software, perspective, size, color intensity, shadows, deviation from the horizon, etc. are maintained (maybe not perfectly in some cases, but close enough for the brain to accommodate).

Animation is very simple using the animation capabilities of the software. As long as the scene or elements within the scene are moved so that corresponding elements are aligned horizontally, the stereographic effect is maintained. Actually, as discussed below, strict horizontal alignment isn't necessary.

The human brain is often capable of resolving discrepancies and of perceiving pleasing, coherent images even when things aren't perfect. For example, if the scene is rotated a bit around the Y-axis, the rows are no longer viewed as absolutely horizontal and the apparent sizes of objects in each row vary. Yet, even under these conditions, the image may just look great. It depends on the skill of the practitioner in laying out the scene, adjusting the viewpoint, and working the camera. For instance in the example just mentioned, moving the camera back and narrowing the field of view will help minimize distorting effects, but will sacrifice some depth perception. The balance between the two is an artistic choice.

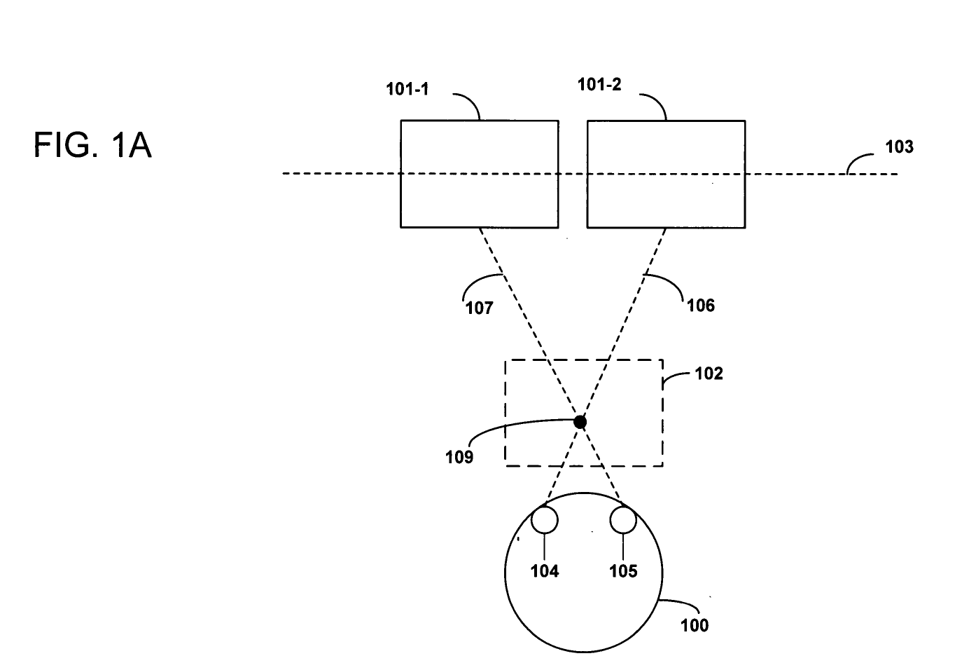

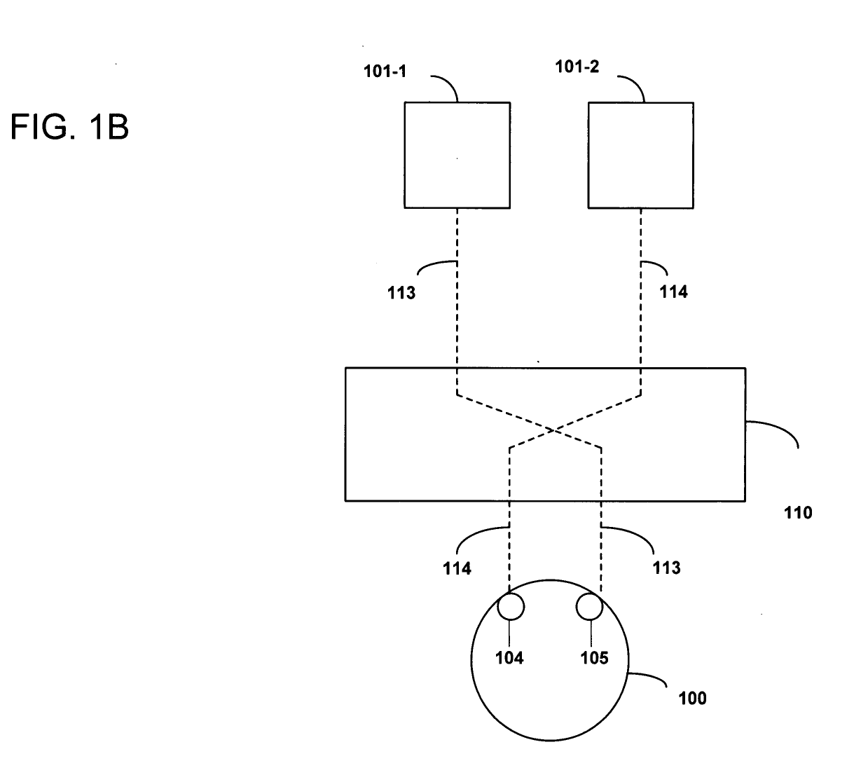

These and other embodiments are described in more detail below with reference to the accompanying figures. FIG. 1A depicts an image viewing method according to an embodiment of the invention. The objects 101-1 and 101-2 are lined up along axis 103, which is horizontal relative to the viewer 100. A viewer 100 looks at objects 101-1 and 101-2 in a cross-eyed manner. The viewer 100's right eye 105 looks at object 101-1 and the viewer 100's left eye 104 looks at object 101-2. As a result the viewer 100 perceives a virtual image 102 resembling objects 101-1 and 101-2 at location 109, which is at the intersection of lines 106 and 107. Note that a similar result may be achieved by looking at a picture that includes the images of objects 101-1 and 101-2 lined up horizontally relative to the viewer 100.

FIG. 1B depicts an image viewing method according to another embodiment of the invention. As shown in FIG. 1B, a light wave 113 reflecting off the object 101-1 is directed by the viewing device 110 to the right eye 105. Similarly, the light wave 114 reflecting off object 101-2 is directed by the viewing device 110 to the left eye 104. The viewing device 110 may include, for example, mirrors for redirecting the light waves 113 and 114. Note that a similar result may be achieved by looking via the viewing device 110 at a picture that includes the images of objects 101-1 and 101-2 lined up horizontally relative to viewer 100.

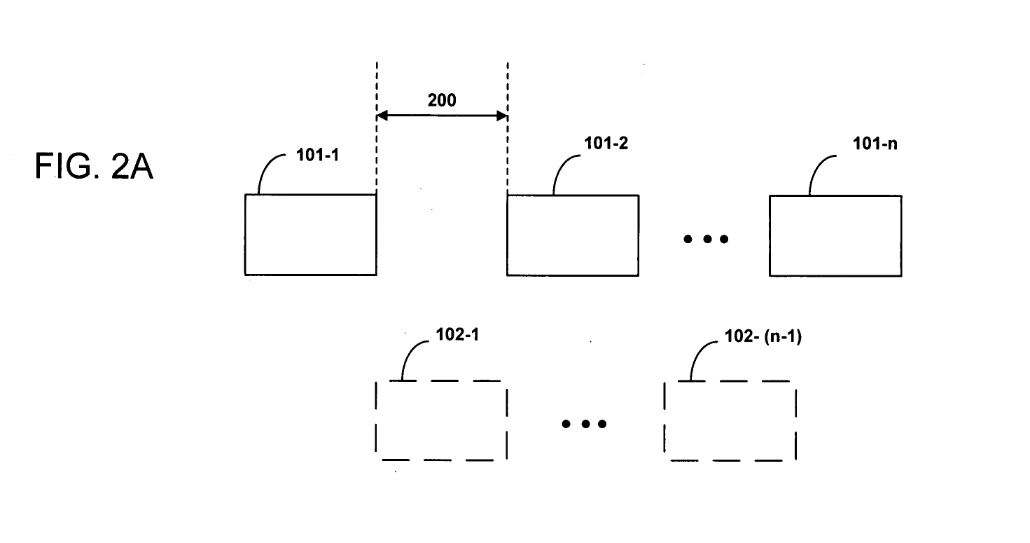

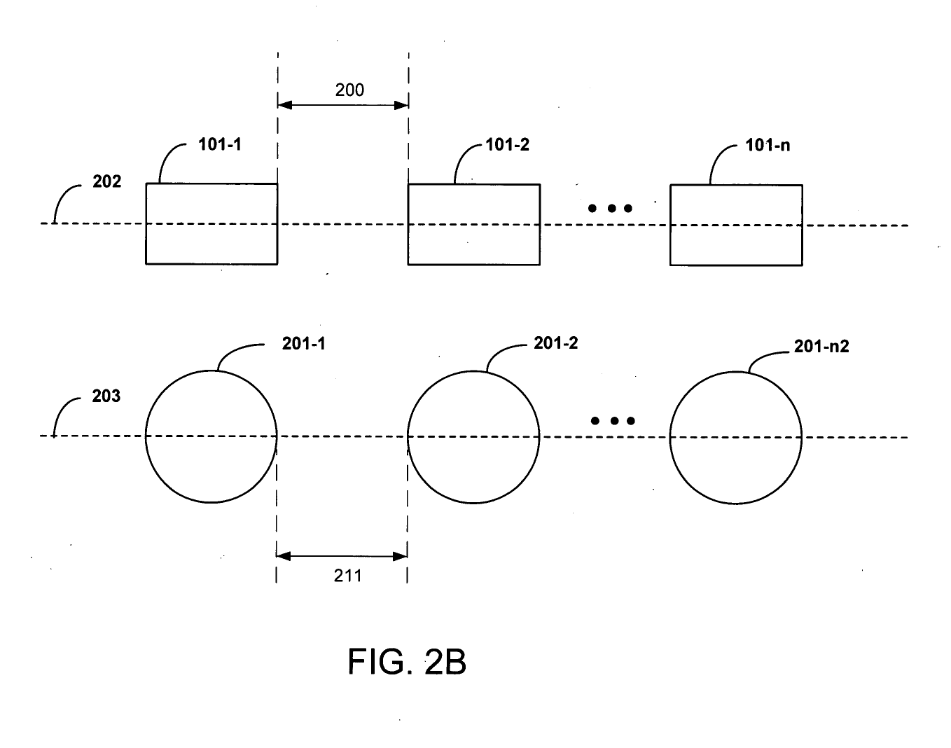

FIG. 2A depicts a row of objects and a row of corresponding virtual images, according to an embodiment of the invention. Virtual three-dimensional viewing of objects may be enhanced by having more than two objects lined up in a straight line. The objects 101-1, 101-2, . . . 101-n are lined up in a straight line such that the distance 200 between each object 101-i and an adjacent object 101-(i+1), is substantially equal to the distance between object 101-i and another adjacent object 101-(i−1), where object 101-i has two adjacent objects. As a result, when the viewer 100 looks at the objects 101-1, 101-2, . . . 101-n in a cross-eyed manner (or via the viewing device 110), the viewer 100 perceives n−1 three dimensional virtual images 102-1, 102-2, . . . 102-n−1. For example, if there are three objects 101-i, then viewer 100 perceives two three-dimensional virtual images 102-i.

FIG. 2B depicts objects positioned according to one embodiment of the invention. The objects 101-1, 101-2, . . . 101-n are lined up along an axis 202 such that the distance 200 between each object 101-i and an adjacent object 101-(i+1), is substantially equal to the distance between object 101-i and another adjacent object 101-(i−1). The objects 201-1, 201-2, . . . 201-n are lined up along an axis 203 such that the distance 211 between each object 201-i and an adjacent object 201-(i+1), is substantially equal to the distance between object 201-i and another adjacent object 201-(i−1). In this embodiment, the axis 202 is substantially parallel to the axis 203. In one implementation, the distance 211 is substantially equal to the distance 200. In another implementation, the distance 211 is substantially different from the distance 200. Note that the shapes of objects depicted in the accompanying figures (e.g., shapes of objects 101-1, 101-2, . . . 101-n, and objects 201-1, 201-2, . . . 201-n) are for illustration purposes only and that objects of various shapes or sizes may be used in various embodiments of the invention. For example, the objects 101-1, 101-2, . . . 101-n and/or the objects 201-1, 201-2, . . . 201-n may be animate or inanimate objects.

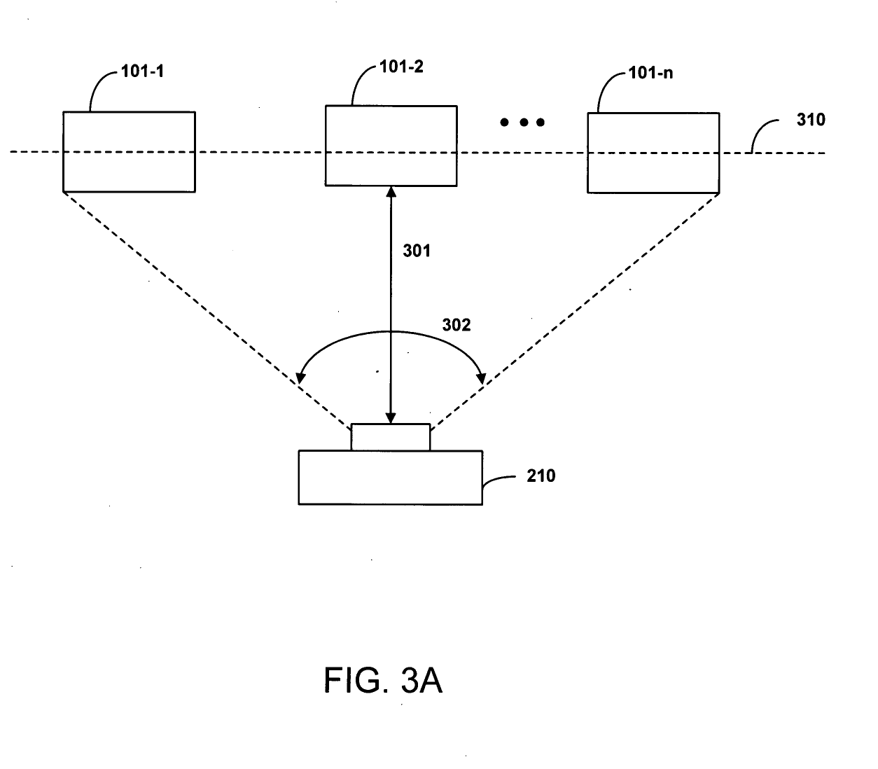

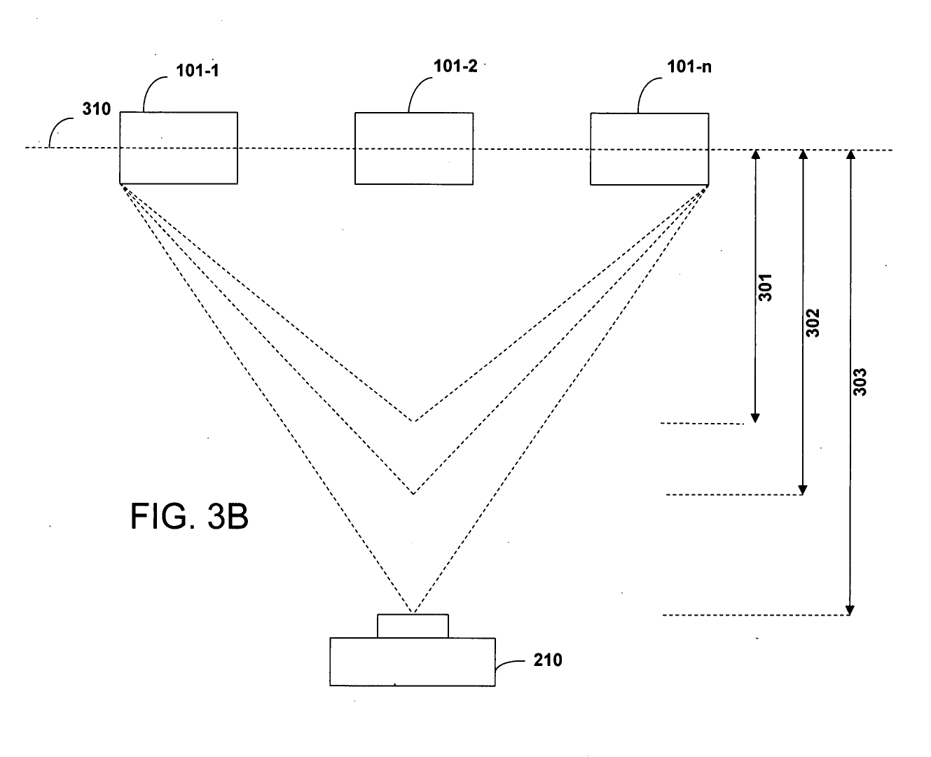

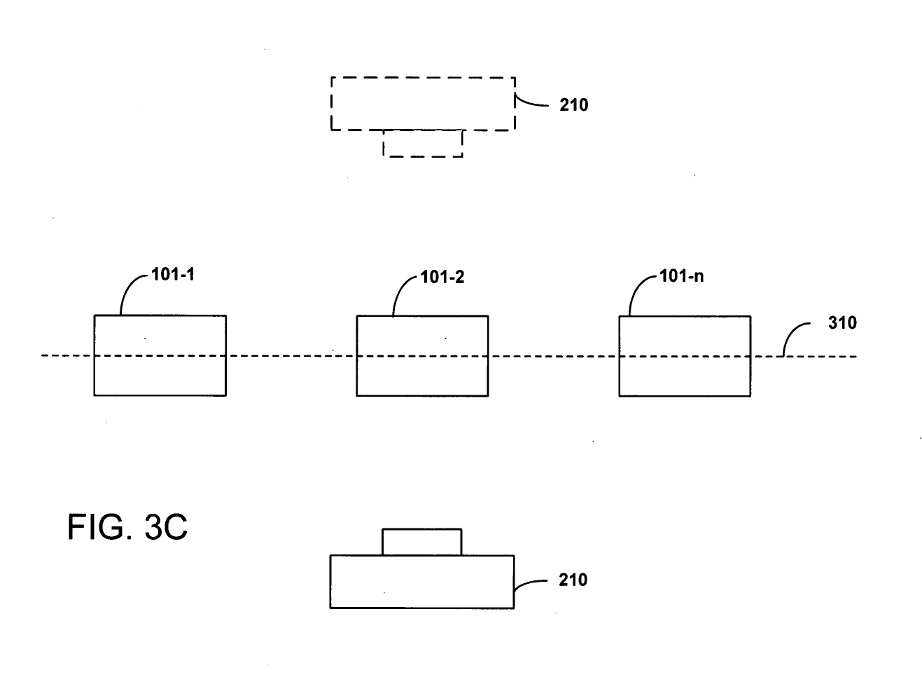

FIG. 3A depicts a camera 210 that is configured to capture an image of a row of objects. As shown in FIG. 3A, the camera 210 captures an image of objects 101-1, 101-2, . . . 101-n, wherein camera 210 is located a distance 301 away from axis 303 and wherein the field of view of camera 210 corresponds to an angle 302. The image captured by camera 210 may produce a three-dimensional effect (as previously discussed) when viewed in a cross-eyed manner or via the viewing device 110. The camera 210 may also be configured to capture a plurality of images of a plurality of rows of objects (e.g., rows of objects shown in FIG. 2B).

FIG. 3B depicts a camera 210 that is configured to capture a plurality of images of one or more rows of objects. As shown in FIG. 3B, camera 210 captures images of a plurality of objects 101-1, 101-2, 101-n at a plurality of respective distances 301, 302, and 303 and at a plurality of corresponding fields of view 304, 305, and 306. Each of these images captured by camera 210 enable a viewer 100 to perceive a three dimensional object when viewed in a cross-eyed manner or via the viewing device 110 (FIG. 1B). Note however that each of the images captured by camera 210 will appear to be different from each of the other pictures. The camera 210 may also be configured to capture a plurality of images of a plurality of rows of objects (e.g., rows of objects shown in FIG. 2B), wherein each of such images is captured at a respective distance from one of the plurality of rows (and at a respective field of view).

FIG. 3C depicts a camera 210 that is configured to capture a plurality of images of a row of objects. The camera 210 may rotate around the axis 310 or around an axis that is substantially parallel to the axis 310. In this manner, the camera 210 may capture images of objects 101-1, 101-2, . . . , 101-n from various angles and/or distances relative to the axis 310. The camera 210 may also be configured to capture a plurality of images of a plurality of rows of objects (e.g., rows of objects shown in FIG. 2B), wherein each of such images is captured at a respective angle relative to the axis corresponding to one of the rows (e.g., axis 310) or around an axis that is substantially parallel to one of the rows.

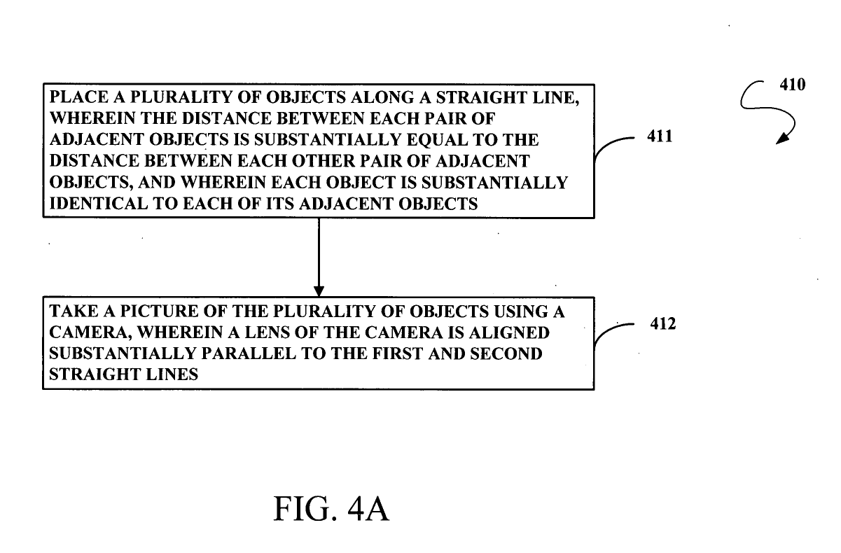

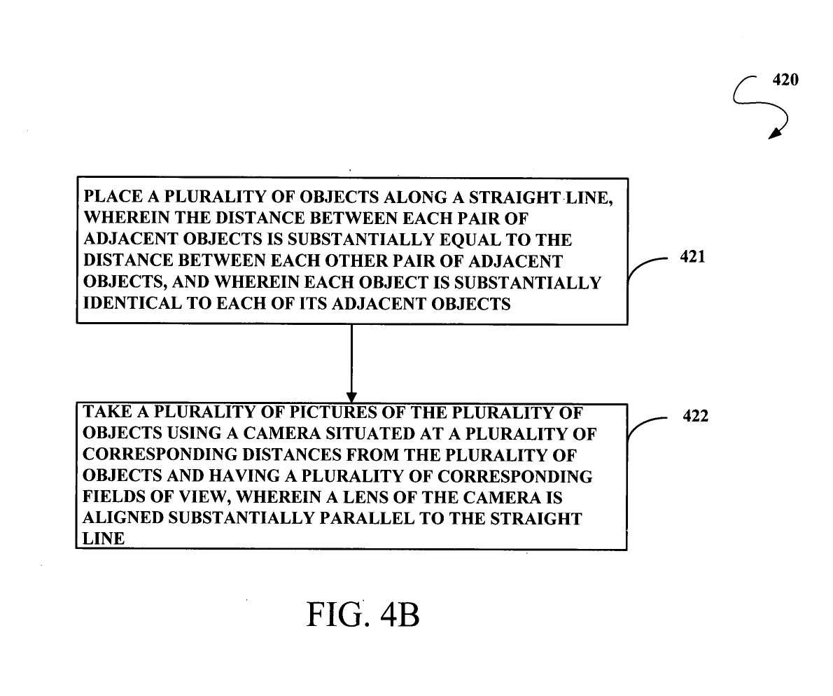

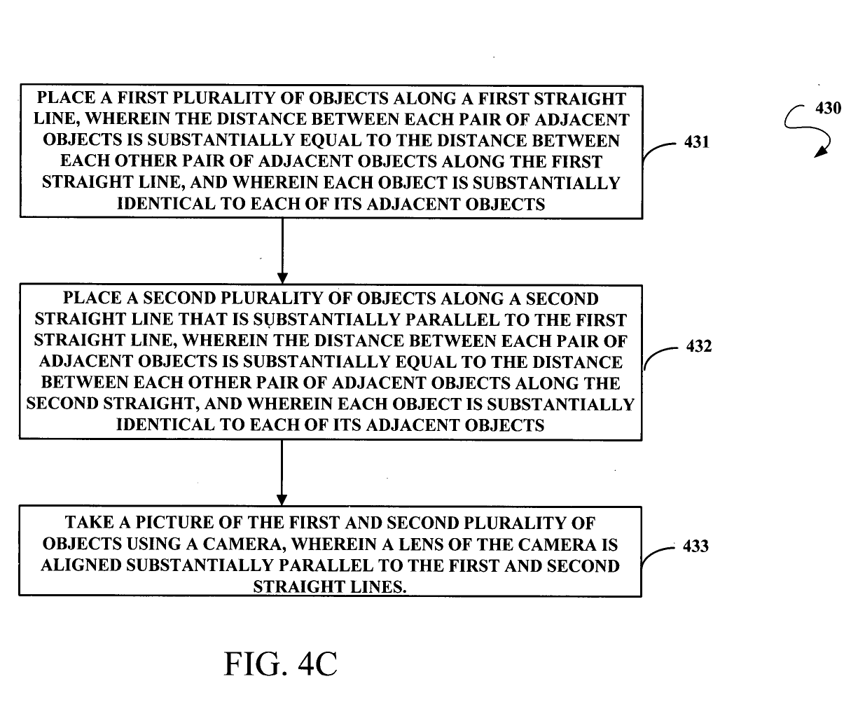

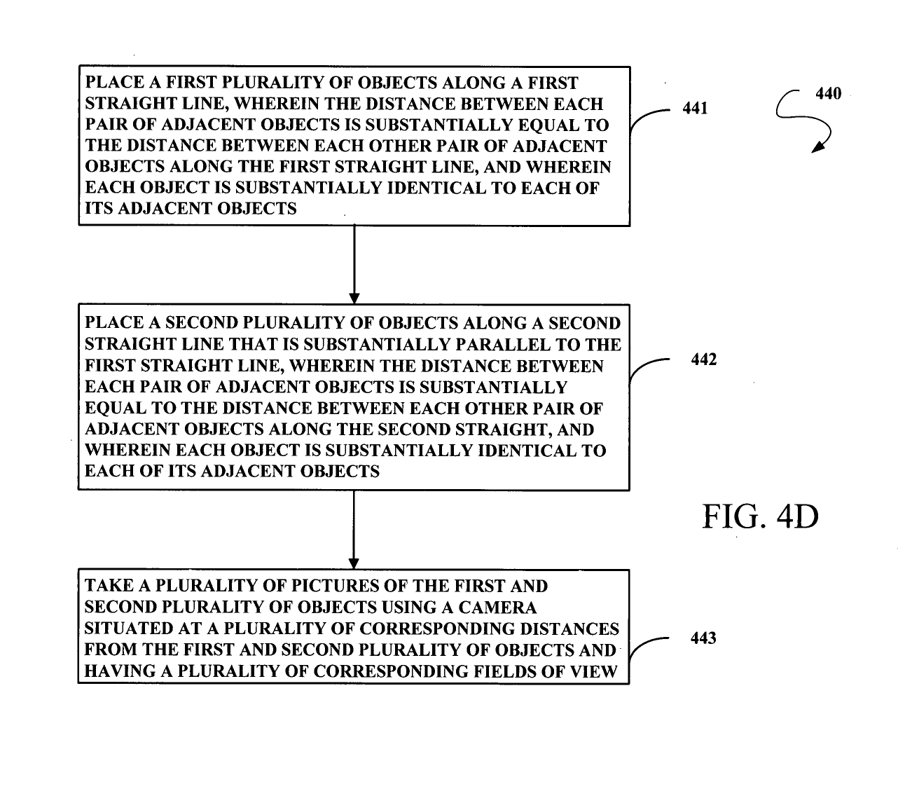

FIG. 4A depicts a method 410 according to an embodiment of the invention. The method 410 includes placing a plurality of objects along a straight line, wherein the distance between each pair of adjacent objects is substantially equal to the distance between each other pair of adjacent objects, and wherein each object is substantially identical to (and has substantially the same orientation as) each of its adjacent objects (411); and taking a picture of the plurality of objects using a camera, wherein a lens of the camera is aligned substantially parallel to the first and second straight lines (412).

FIG. 4B depicts a method 420 according to an embodiment of the invention. The method 420 includes placing a plurality of objects along a straight line, wherein the distance between each pair of adjacent objects is substantially equal to the distance between each other pair of adjacent objects, and wherein each object is substantially identical to (and has substantially the same orientation as) each of its adjacent objects (421); and taking a plurality of pictures of the plurality of objects using a camera situated at a plurality of corresponding distances from the plurality of objects and has a plurality of corresponding fields of view, wherein a lens of the camera is aligned substantially parallel to the straight line (422).

FIG. 4C depicts a method 430 according to an embodiment of the invention. The method 430 includes placing a first plurality of objects along a first straight line, wherein the distance between each pair of adjacent objects is substantially equal to the distance between each other pair of adjacent objects along the first straight line, and wherein each object is substantially identical to (and has substantially the same orientation as) each of its adjacent objects (431); placing a second plurality of objects along a second straight line that is substantially parallel to the first straight line, wherein the distance between each pair of adjacent objects is substantially equal to the distance between each other pair of adjacent objects along the second straight, and wherein each object is substantially identical to (and has substantially the same orientation as) each of its adjacent objects (432); and taking a picture of the first and second plurality of objects using a camera, wherein a lens of the camera is aligned substantially parallel to the first and second straight lines (433).

FIG. 4D depicts a method 440 according to an embodiment of the invention. The method 440 includes placing a first plurality of objects along a first straight line, wherein the distance between each pair of adjacent objects is substantially equal to the distance between each other pair of adjacent objects along the first straight line, and wherein each object is substantially identical to (and has substantially the same orientation as) each of its adjacent objects (441); placing a second plurality of objects along a second straight line that is substantially parallel to the first straight line, wherein the distance between each pair of adjacent objects is substantially equal to the distance between each other pair of adjacent objects along the second straight, and wherein each object is substantially identical to (and has substantially the same orientation as) each of its adjacent objects (442); and taking a plurality of pictures of the first and second plurality of objects using a camera situated at a plurality of corresponding distances from the first and second plurality of objects and has a plurality of corresponding fields of view (443).

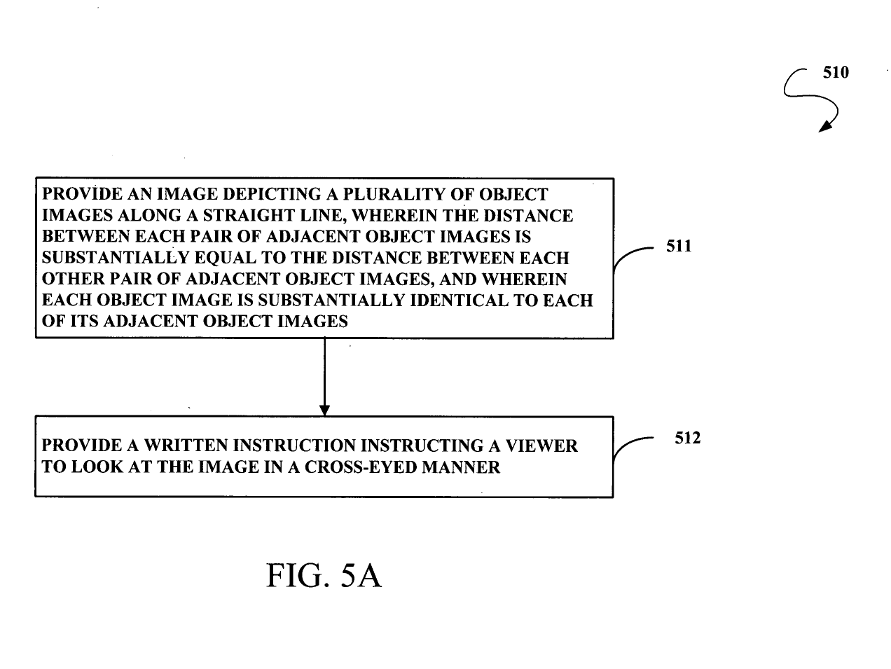

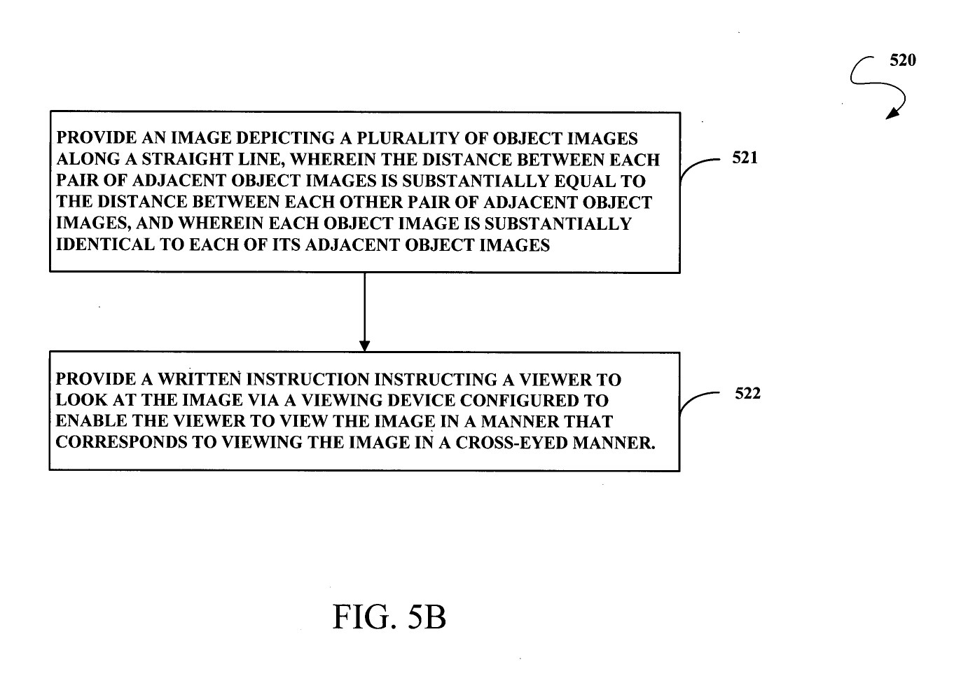

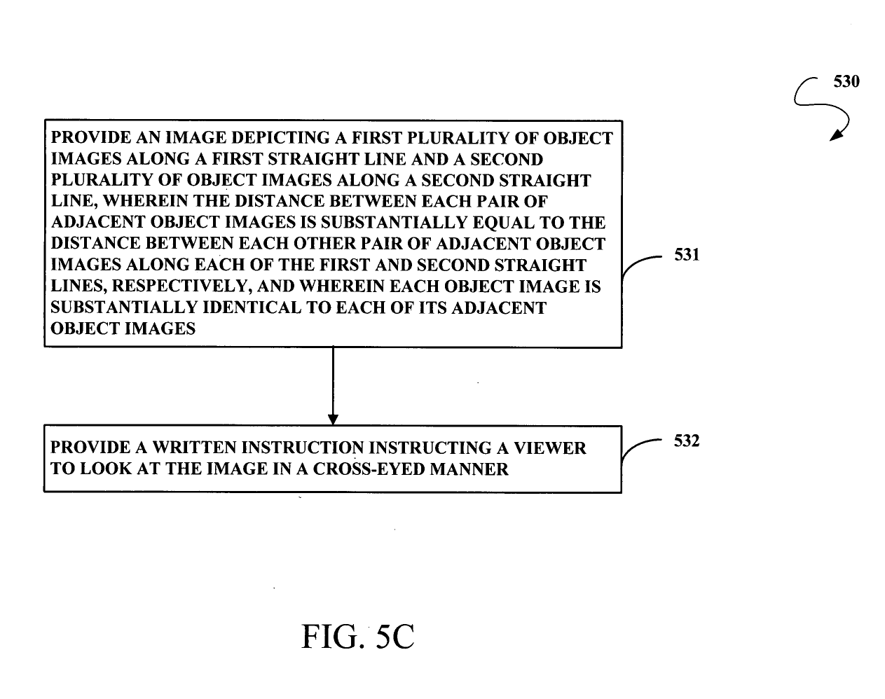

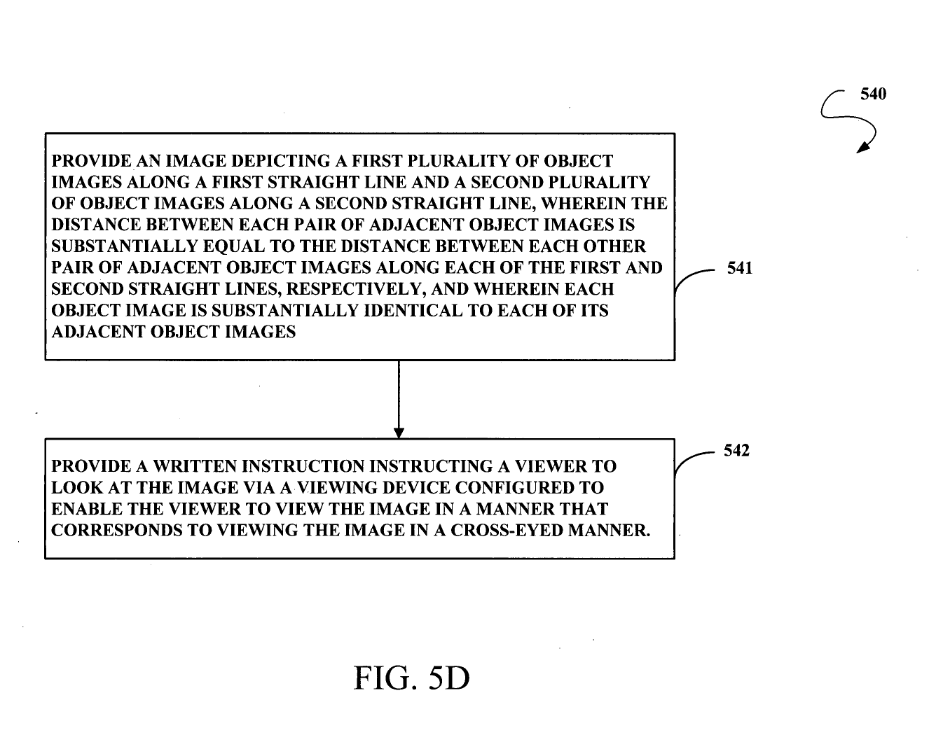

FIG. 5A depicts a method 510 according to an embodiment of the invention. The method 510 includes providing an image depicting a plurality of object images along a straight line, wherein the distance between each pair of adjacent object images is substantially equal to the distance between each other pair of adjacent object images, and wherein each object image is substantially identical to (and has substantially the same orientation as) each of its adjacent object images (511); and providing an instruction (e.g., written or oral) instructing a viewer to look at the image in a cross-eyed manner (512).

FIG. 5B depicts a method 520 according to an embodiment of the invention. The method 520 includes providing an image depicting a plurality of object images along a straight line, wherein the distance between each pair of adjacent object images is substantially equal to the distance between each other pair of adjacent object images, and wherein each object image is substantially identical to (and has substantially the same orientation as) each of its adjacent object images (521); and providing an instruction (e.g., written or oral) instructing a viewer to look at the image via a viewing device configured to enable the viewer to viewing the image in a manner that corresponds to viewing the image in a cross-eyed manner (522).

FIG. 5C depicts a method 530 according to an embodiment of the invention. The method 530 includes providing an image depicting a first plurality of object images along a first straight line and a second plurality of object images along a second straight line, wherein the distance between each pair of adjacent object images is substantially equal to the distance between each other pair of adjacent object images along each of the first and second straight lines, respectively, and wherein each object image is substantially identical to (and has substantially the same orientation as) each of its adjacent object images (531); and providing an instruction (e.g., written or oral) instructing a viewer to look at the image in a cross-eyed manner (532).

FIG. 5D depicts a method 540 according to an embodiment of the invention. The method 540 includes providing an image depicting a first plurality of object images along a first straight line and a second plurality of object images along a second straight line, wherein the distance between each pair of adjacent object images is substantially equal to the distance between each other pair of adjacent object images along each of the first and second straight lines, respectively, and wherein each object image is substantially identical to (and has substantially the same orientation as) each of its adjacent object images (541); and providing an instruction (e.g., written or oral) instructing a viewer to look at the image via a viewing device configured to enable the viewer to viewing the image in a manner that corresponds to viewing the image in a cross-eyed manner (542).

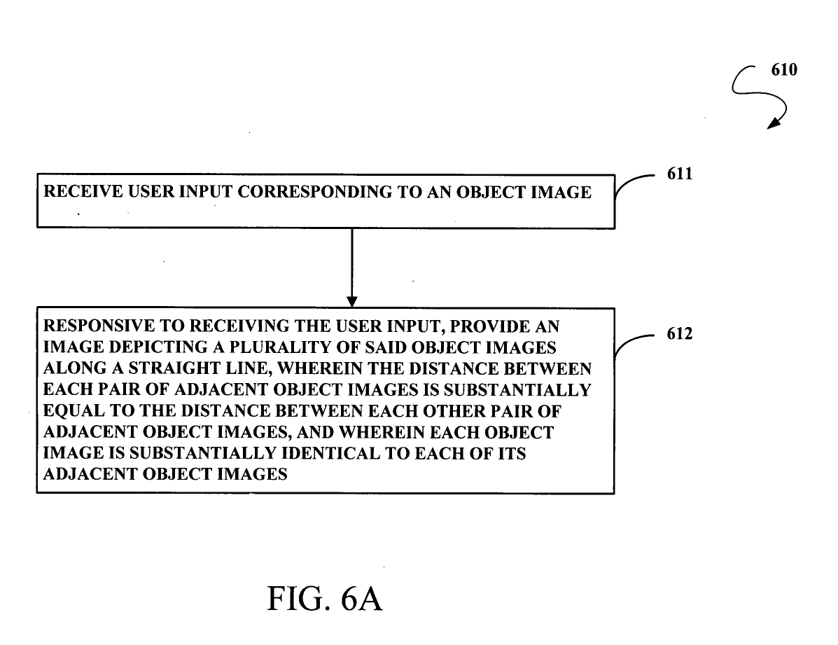

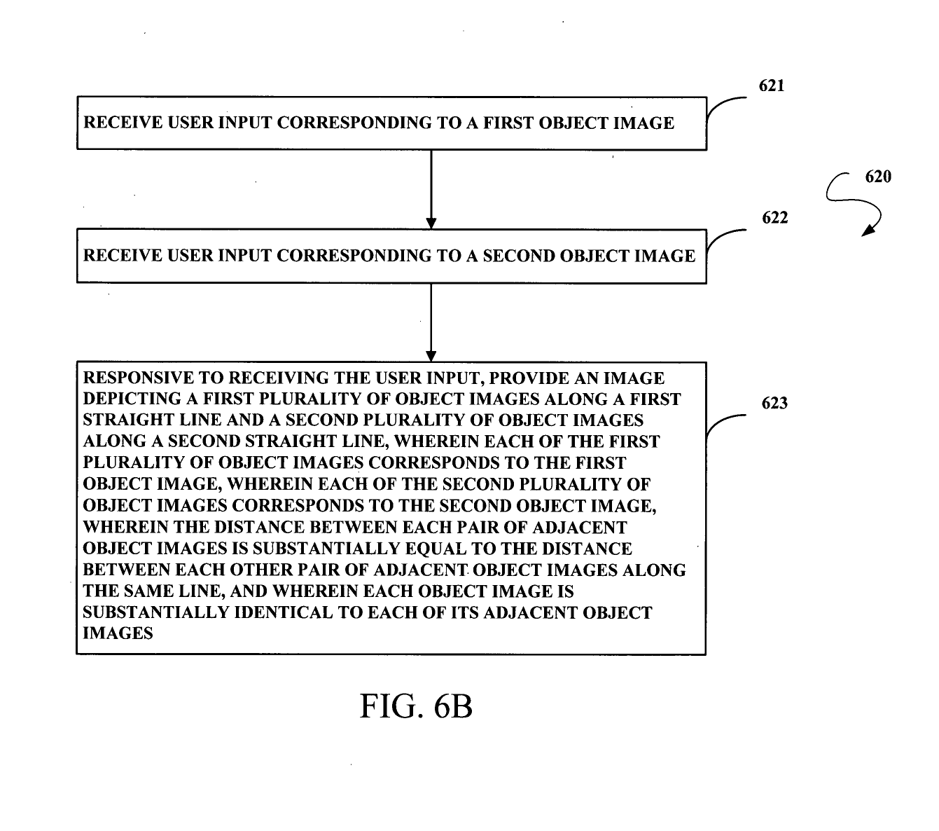

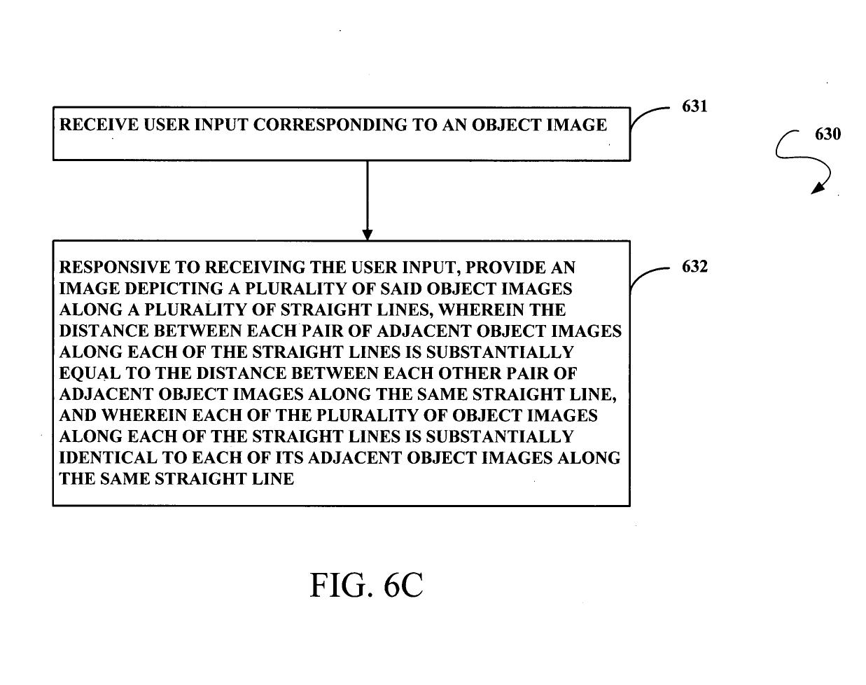

FIGS. 6A-6C depict respective methods 610, 620, and 630 that may be implemented via a computer system. FIG. 6A depicts a method 610 according to an embodiment of the invention. The method 610 includes receiving user input corresponding to an object image (611); and responsive to receiving the user input, providing an image depicting a plurality of said object images along a straight line, wherein the distance between each pair of adjacent object images is substantially equal to the distance between each other pair of adjacent object images, and wherein each object image is substantially identical to (and has substantially the same orientation as) each of its adjacent object images (612).

FIG. 6B depicts a method 620 according to an embodiment of the invention. The method 620 includes receiving user input corresponding to a first object image (621); receiving user input corresponding to a second object image (622); and responsive to receiving the user input, providing an image depicting a first plurality of object images along a first straight line and a second plurality of object images along a second straight line, wherein each of the first plurality of object images corresponds to the first object image, wherein each of the second plurality of object images corresponds to the second object image, wherein the distance between each pair of adjacent object images is substantially equal to the distance between each other pair of adjacent object images along the same line, and wherein each object image is substantially identical to (and has substantially the same orientation as) each of its adjacent object images (623).

FIG. 6C depicts a method 630 according to an embodiment of the invention. The method 630 includes receiving user input corresponding to an object image (631); and responsive to receiving the user input, providing an image depicting a plurality of said object images along a plurality of straight lines, wherein the distance between each pair of adjacent object images along each of the straight lines is substantially equal to the distance between each other pair of adjacent object images along the same straight line, and wherein each of the plurality of object images along each of the straight lines is substantially identical to (and has substantially the same orientation as) each of its adjacent object images along the same straight line (632).

The images provided via methods 610, 620, and 630 may be output via, for example, a computer monitor and/or a printer. Furthermore, the images provided via methods 610, 620, and 630 may also be responsive to additional user input such as, for example, user input specifying characteristics of the object images, the relative location of the object images, and/or the viewing angle or distance depicted by the image. In one embodiment, the user input merely selects an object image, and a stereographic image comprising one or more rows of the selected object image is generated responsive to the object image selection.

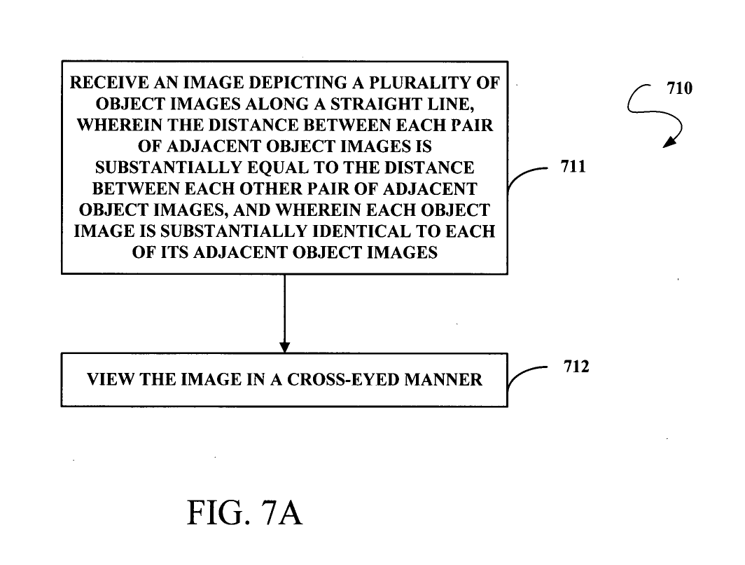

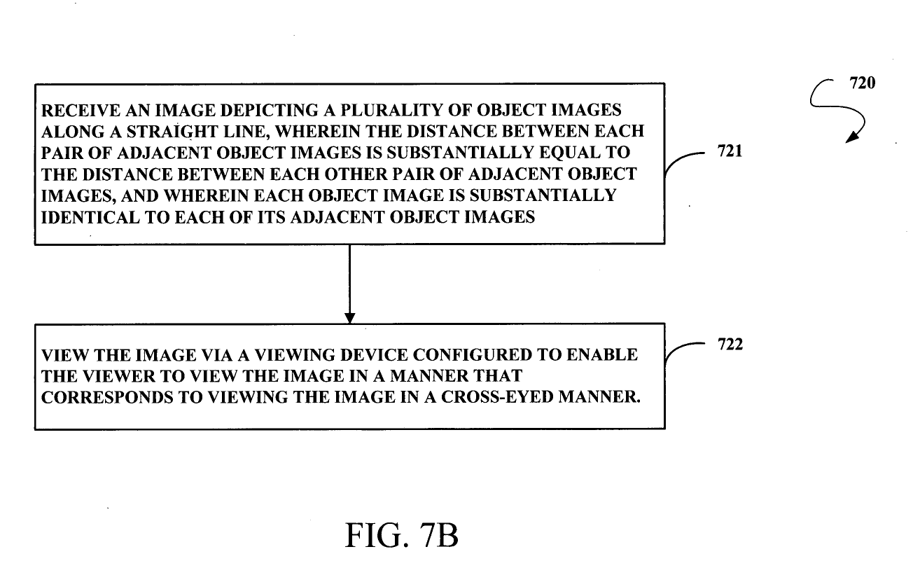

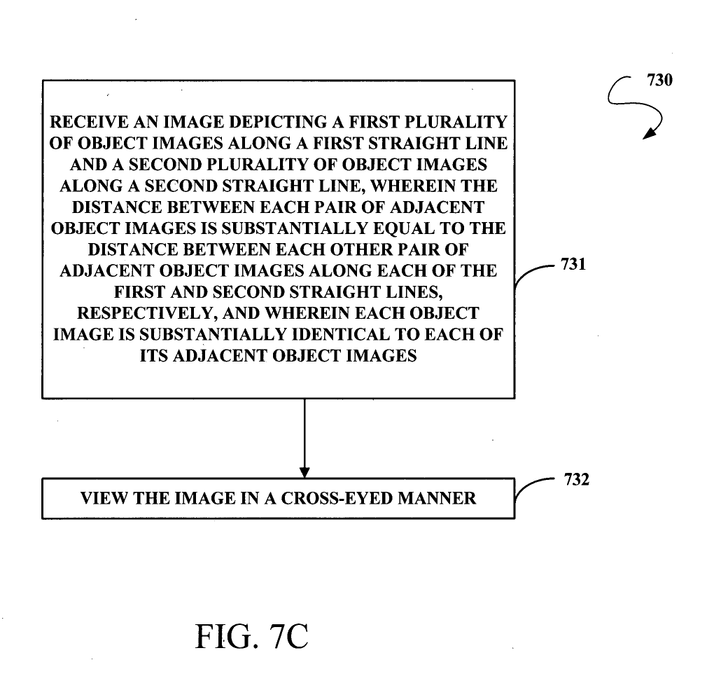

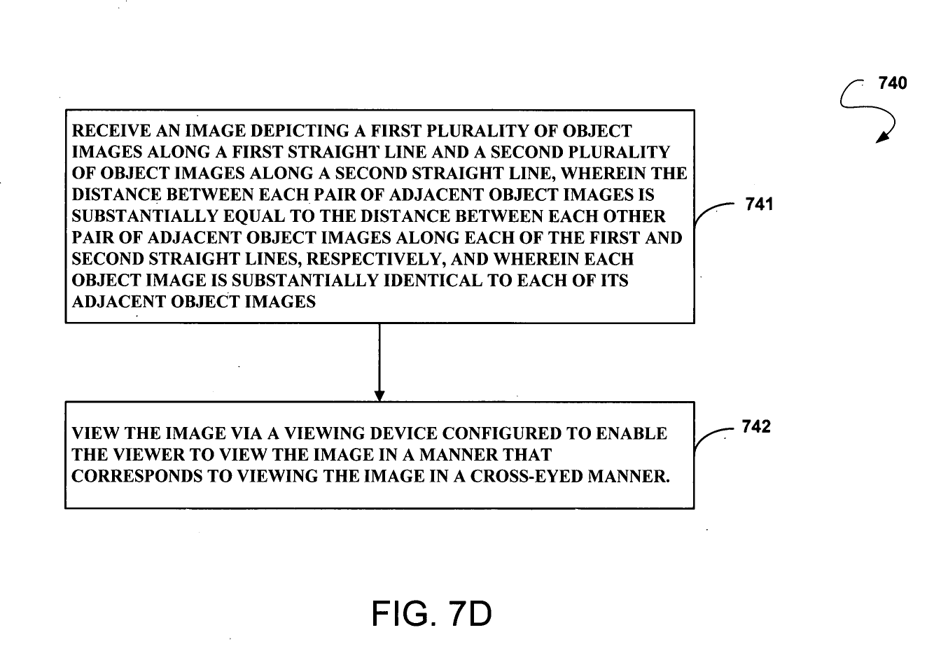

FIG. 7A depicts a method 710 according to an embodiment of the invention. The method 710 includes receiving an image depicting a plurality of object images along a straight line, wherein the distance between each pair of adjacent object images is substantially equal to the distance between each other pair of adjacent object images, and wherein each object image is substantially identical to (and has substantially the same orientation as) each of its adjacent object images (711); and viewing the image in a cross-eyed manner (712).

FIG. 7B depicts a method 720 according to an embodiment of the invention. The method 720 includes receiving an image depicting a plurality of object images along a straight line, wherein the distance between each pair of adjacent object images is substantially equal to the distance between each other pair of adjacent object images, and wherein each object image is substantially identical to (and has substantially the same orientation as) each of its adjacent object images (721); and viewing the image via a viewing device configured to enable the viewer to viewing the image in a manner that corresponds to viewing the image in a cross-eyed manner (722).

FIG. 7C depicts a method 730 according to an embodiment of the invention. The method 730 includes receiving an image depicting a first plurality of object images along a first straight line and a second plurality of object images along a second straight line, wherein the distance between each pair of adjacent object images is substantially equal to the distance between each other pair of adjacent object images along each of the first and second straight lines, respectively, and wherein each object image is substantially identical to (and has substantially the same orientation as) each of its adjacent object images (731); and viewing the image in a cross-eyed manner (732).

FIG. 7D depicts a method 740 according to an embodiment of the invention. The method 740 includes receiving an image depicting a first plurality of object images along a first straight line and a second plurality of object images along a second straight line, wherein the distance between each pair of adjacent object images is substantially equal to the distance between each other pair of adjacent object images along each of the first and second straight lines, respectively, and wherein each object image is substantially identical to (and has substantially the same orientation as) each of its adjacent object images (741); and viewing the image via a viewing device configured to enable the viewer to viewing the image in a manner that corresponds to viewing the image in a cross-eyed manner (742).

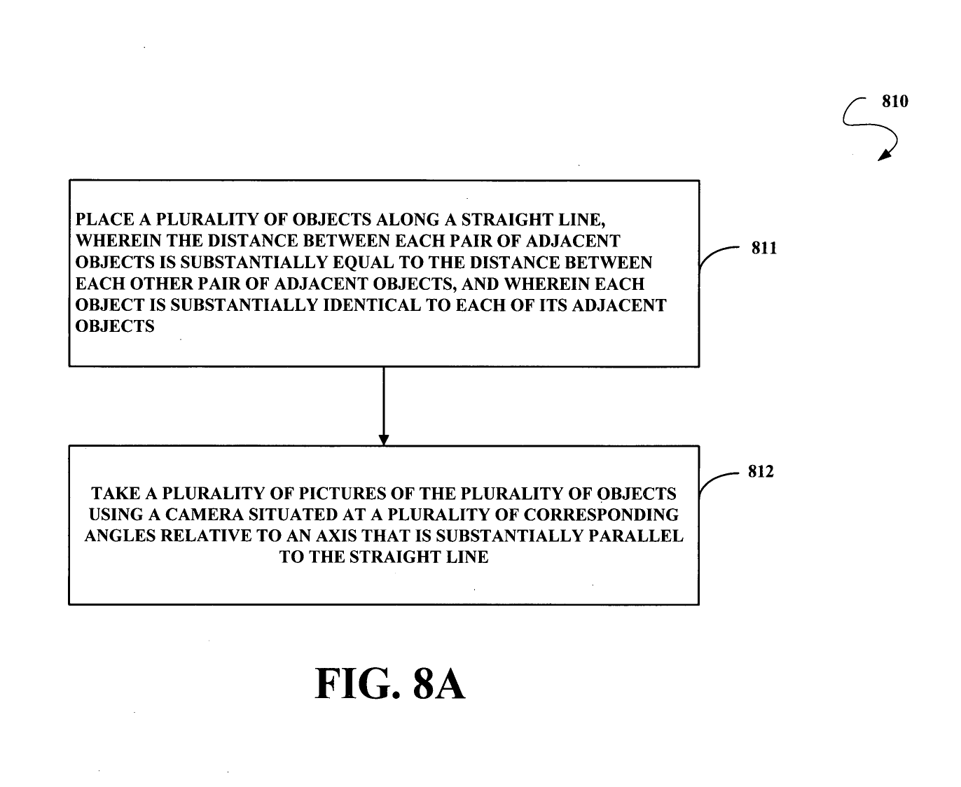

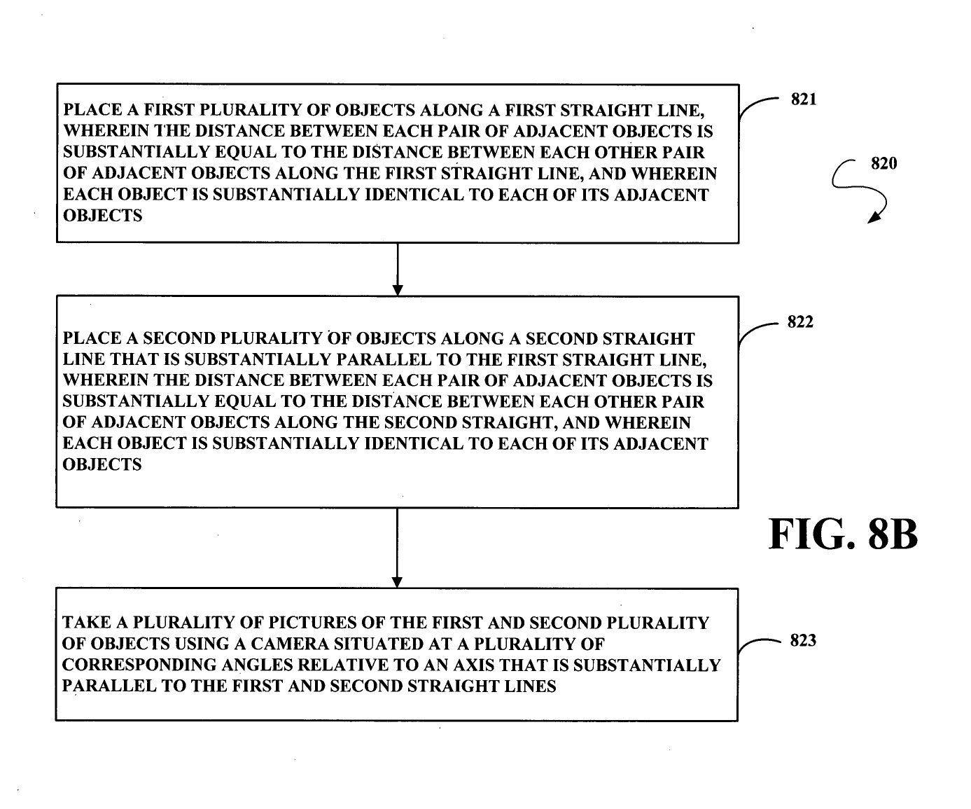

FIG. 8A is a flow chart depicting a method 810 according to an embodiment of the invention. The method 810 includes: placing a plurality of objects along a straight line, wherein the distance between each pair of adjacent objects is substantially equal to the distance between each other pair of adjacent objects, and wherein each object is substantially identical to (and has substantially the same orientation as) each of its adjacent objects (step 811), and taking a plurality of pictures of the plurality of objects using a camera situated at a plurality of corresponding angles relative to an axis that is substantially parallel to the straight line (step 812).

FIG. 8B is a flow chart depicting a method 820 according to an embodiment of the invention. The method 820 includes: placing a first plurality of objects along a first straight line, wherein the distance between each pair of adjacent objects is substantially equal to the distance between each other pair of adjacent objects along the first straight line, and wherein each object is substantially identical to (and has substantially the same orientation as) each of its adjacent objects (step 821), placing a second plurality of objects along a second straight line that is substantially parallel to the first straight line, wherein the distance between each pair of adjacent objects is substantially equal to the distance between each other pair of adjacent objects along the second straight, and wherein each object is substantially identical to (and has substantially the same orientation as) each of its adjacent objects (step 822), and taking a plurality of pictures of the first and second plurality of objects using a camera situated at a plurality of corresponding angles relative to an axis that is substantially parallel to the first and second straight lines (step 823).

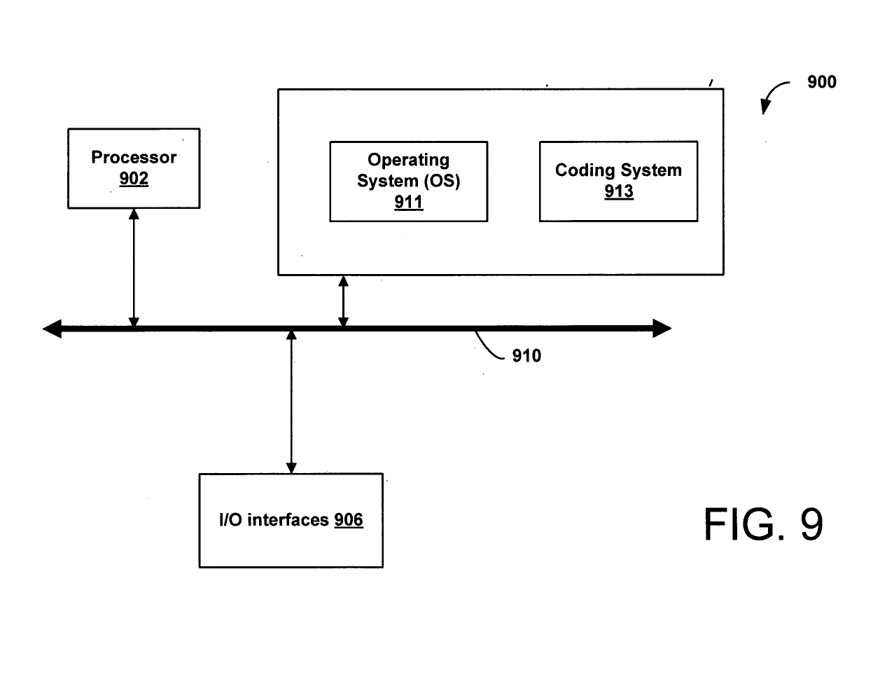

FIG. 9 is a block diagram depicting a non-limiting example of a computer system (CS) 900 that can be used to implement the methods depicted in FIGS. 6A-6C. The CS 900 may be a digital computer that, in terms of hardware architecture, generally includes a processor 902, memory system 904, and input/output (I/O) interfaces 906. These components (902, 904, and 906) are communicatively coupled via a local interface 910. The local interface 910 can be, for example but not limited to, one or more buses or other wired or wireless connections, as is known in the art. The local interface 910 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 902 is a hardware device for executing software, particularly that stored in memory system 904. The processor 902 can be any custom made or commercially available processor, a central processing unit (CPU), an auxiliary processor among several processors associated with the CS 900, a semiconductor-based microprocessor (in the form of a microchip or chip set), or generally any device for executing software instructions. When the CS 900 is in operation, the processor 902 is configured to execute software stored within the memory system 904, to communicate data to and from the memory system 904, and to generally control operations of the CS 900 pursuant to the software.

The I/O interfaces 906 may be used to receive user input from and/or to provide system output to one or more devices or components. User input may be provided via, for example, a keyboard and/or a mouse. System output may be provided via a display device and a printer (not shown). Communication interfaces 906 may include, for example, a serial port, a parallel port, a Small Computer System Interface (SCSI), an IR interface, an RF interface, and/or a universal serial bus (USB) interface.

The memory system 904 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory system 904 may incorporate electronic, magnetic, optical, and/or other types of storage media. Note that the memory system 904 can have a distributed architecture, where various components are situated remote from one another, but can be accessed by the processor 902.

The software in memory system 904 may include one or more software programs, each of which comprises an ordered listing of executable instructions for implementing logical functions. In the example of FIG. 9, the software in the memory system 904 includes an imaging system 913 and a suitable operating system (O/S) 911. The imaging system 913 may be used for generating stereographic images responsive to user input. For example, the imaging system 913 may enable a user to place object images in a virtual 3D environment and then generate one or more perspective views of the object images based on parameters provided by the user (e.g., viewing distance and field of view). The operating system 911 essentially controls the execution of other computer programs, such as the imaging system 913, and provides scheduling, input-output control, file and data management, memory management, and communication control and related services.

If the CS 900 is a desktop computer, notebook computer, workstation, or the like, software in the memory system 904 may include a basic input output system (BIOS) (not shown). The BIOS is a set of essential software routines that initialize and test hardware at startup, start the O/S 911, and support the transfer of data among the hardware devices. The BIOS is stored in ROM so that the BIOS can be executed when the CS 900 is activated.

The imaging system 913 may be a source program, an executable program (object code), a script, or any other entity comprising a set of instructions to be performed. When the imaging system 913 is a source program, then the imaging system 913 may be translated via a compiler, assembler, interpreter, or the like, which may or may not be included within the memory system 904, so as to operate properly in connection with the O/S 911. Furthermore, the imaging system 913 can be written as (a) an object oriented programming language, which has classes of data and methods, or (b) a procedure programming language, which has routines, subroutines, and/or functions, such as, for example, but not limited to, C, C++, Pascal, Basic, Fortran, Cobol, Perl, and Java.

When the imaging system 913 is implemented in software, as is shown in FIG. 9, it should be noted that the imaging system 913 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The imaging system 913 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, the imaging system 913 may be implemented in hardware using, for example, any or a combination of the following technologies which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

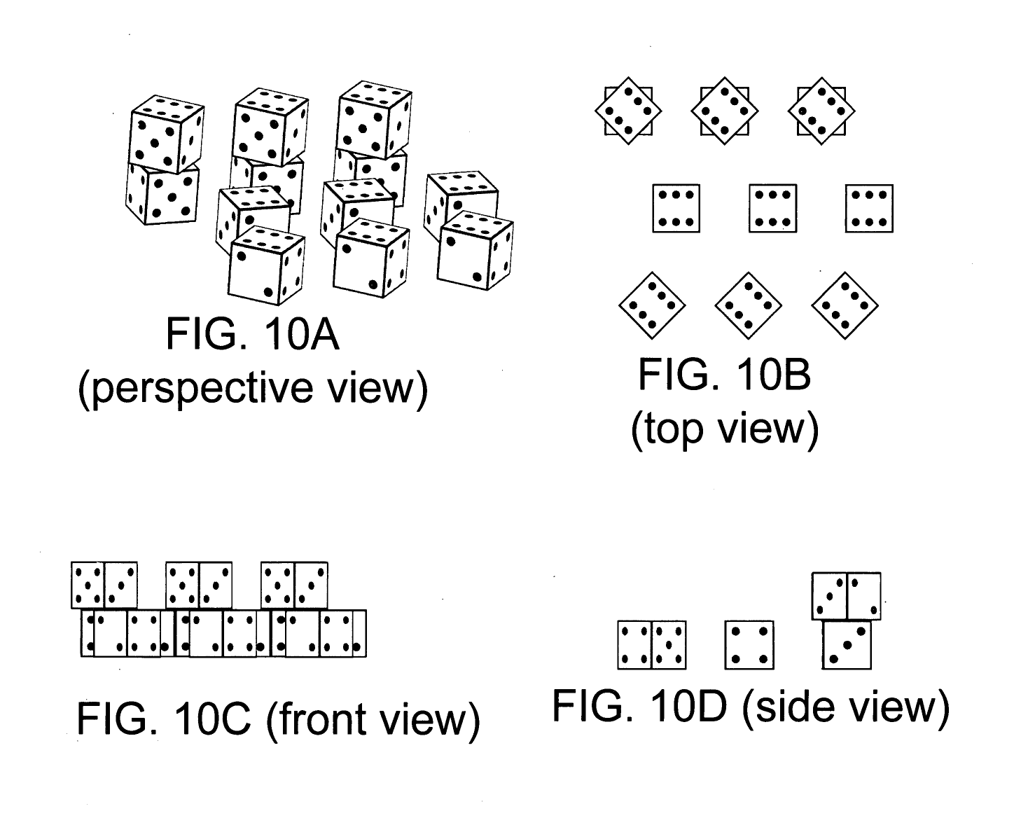

FIGS. 10A-10D depict respective views or images (perspective, top, front, and side views, respectively) of an example object arrangement in accordance with an embodiment of the invention. As shown in FIGS. 10A-10D, four rows of dice are placed in proximity to each other, with each row comprising three dice. Each die in each row of dice has substantially the same orientation as each other die in the same row of dice. Furthermore, the distance between adjacent dice in each row of dice is substantially uniform along the row of dice.

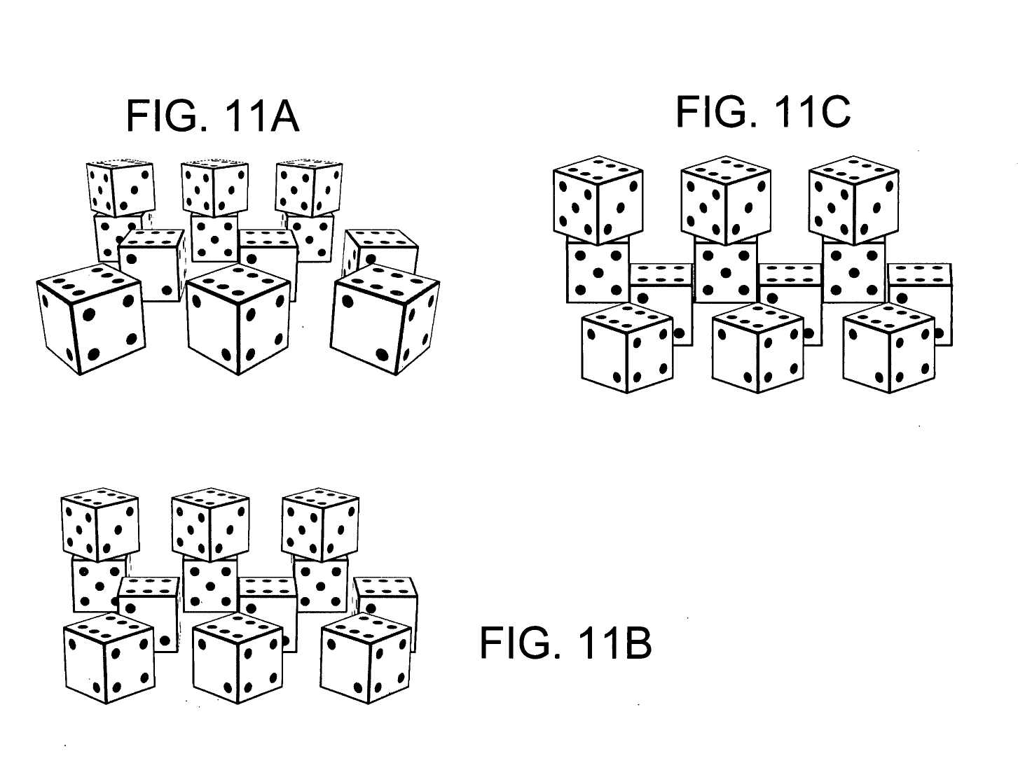

FIGS. 11A-11C depict respective camera views or images of an object arrangement in accordance with an embodiment of the invention. As shown in FIGS. 11A-11C, four rows of dice are placed in proximity to each other, with each row comprising three dice. Each die in each row of dice has substantially the same orientation as each other die in the same row of dice. Furthermore, the distance between adjacent dice in each row of dice is substantially uniform along the row of dice.

Each camera view or image has a corresponding camera distance (from the objects) as well as a respective field of view. As the camera gets farther away from the objects, the field of view is narrowed, and vice versa. The images depicted in FIGS. 11A-11C may be examined to determine which image is most suitable for producing a stereographic effect.

It should be emphasized that the above-described embodiments of the present invention are merely possible examples, among others, of the implementations, setting forth a clear understanding of the principles of the invention. Many variations and modifications may be made to the above-described embodiments of the invention without departing substantially from the principles of the invention. All such modifications and variations are intended to be included herein within the scope of the disclosure and present invention and protected by the following claims.

For example, The following are some examples of deviations from the afore-mentioned techniques:
Rotating rows or scene about Y-Axis
Rotating rows or scene about Z-Axis
Rotating rows or scene about X,Y, and Z Axes
Varying the sizes of objects in a row (e.g., an object may have a slightly different size (e.g., less than 10%) from an adjacent object).
Varying the color of objects in a row (e.g., an object may have a slightly different color (e.g., less than a 10% color change relative to a full color spectrum) from an adjacent object)
Varying the shape of objects in a row (e.g., an object may have a slightly different shape from an adjacent object such that adjacent objects have are still substantially similar).
Rotating objects in a certain row (e.g., an object may have a slightly orientation (e.g., less than 10 degrees of rotation) from an adjacent object)
Varying spacing between objects in the same row (e.g., an object may have slightly different distances (e.g., less than 10% variation in distances) from adjacent objects)
Varying object spacing between rows (e.g., objects in one row may be spaced apart differently from objects in an adjacent row)
Varying depth of objects within a row (e.g., an object may have a slightly different depth (e.g., less than 10% variation in depth) than an adjacent object).

What I claim is:

1. A method for implementing stereography, said method comprising:
placing a first plurality of objects along a first straight line, wherein the distance between each pair of adjacent objects is substantially equal to the distance between each other pair of adjacent objects along the first straight line, and wherein each object is substantially identical to, and has substantially the same orientation as, each of its adjacent objects; and
taking a picture of the first plurality of objects using a camera, wherein a lens of the camera is aligned substantially parallel to the first and second straight lines.

2. The method of claim 1, further comprising:
placing a second plurality of objects along a second straight line that is substantially parallel to the first straight line, wherein the distance between each pair of adjacent objects along the second straight line is substantially equal to the distance between each other pair of adjacent objects along the second straight, and wherein each object along the second straight line is substantially identical to, and has substantially the same orientation as, each of its adjacent objects along the second straight line;
wherein taking the picture of the first plurality of objects comprises taking a picture of the second plurality of objects.

3. The method of claim 2, further comprising:
taking a plurality of pictures of the first and second plurality of objects using a camera situated at a plurality of corresponding distances from the plurality of objects and has a plurality of corresponding fields of view.

4. The method of claim 2, further comprising:
taking a plurality of pictures of the first and second plurality of objects using a camera situated at a plurality of corresponding angles relative to an axis that is parallel to the first straight line.

5. A method for implementing stereography, said method comprising:
providing an image depicting a first plurality of object images along a first straight line, wherein the distance between each pair of adjacent object images along the first straight line is substantially equal to the distance between each other pair of adjacent object images along the first straight line, and wherein each object image along the first straight line is substantially identical to, and has substantially the same orientation as, each of its adjacent object images along the first straight line; and
providing an instruction instructing a viewer to look at the image in a manner that corresponds to viewing the image in a cross-eyed manner.

6. The method of claim 5, wherein the image depicts a second plurality of object images along a second straight line that is parallel to the second straight line, wherein the distance between each pair of adjacent object images along the second straight line is substantially equal to the distance between each other pair of adjacent object images along the second straight line, and wherein each object image along the second straight line is substantially identical to, and has substantially the same orientation as, each of its adjacent object images along the second straight line.

7. The method of claim 6, wherein the instruction instructs the viewer to view the image in a cross-eyed manner.

8. The method of claim 6, wherein the instruction instructs the viewer to view the image via a viewing device configured to enable the viewer to view the image in a manner that corresponds to viewing the image in a cross-eyed manner.

9. The method of claim 5, wherein the image is generated by a computer.

10. A computer that is configured to:
receive user input; and
responsive to receiving the user input, providing an image depicting a first plurality of object images along a first straight line and a second plurality of object images along a second straight line that is parallel to the first straight line;
wherein the distance between each pair of adjacent object images along the first straight line is substantially equal to the distance between each other pair of adjacent object images along the first straight line, and wherein each object image along the first straight line is substantially identical to, and has substantially the same orientation as, each of its adjacent object images along the first straight line; and
wherein the distance between each pair of adjacent object images along the second straight line is substantially equal to the distance between each other pair of adjacent object images along the second straight line, and wherein each object image along the second straight line is substantially identical to, and has substantially the same orientation as, each of its adjacent object images along the second straight line.

11. The method of claim 10, wherein the image is provided via a computer monitor.

12. The method of claim 10, wherein the image is provided via a printer.
